(19) United States
(12) Patent Application Publication
(10) Pub. No.: US 2004/0028030 A1
(43) Pub. Date: Feb. 12, 2004

(54) Method for dialing an internet protocol phone

(76) Inventors: Cheng-Shing Lai, Taipei (TW); Xiao-Long Fan, Nanjing (CN); Xiao-Wen Liu, NanJing (CN)

Correspondence Address: RABIN & Berdo, PC, 1101 14TH STREET, NW, SUITE 500, WASHINGTON, DC, 20005, US

(21) Appl. No.: 10/216,568

(22) Filed: Aug. 12, 2002

(51) Int. Cl. H04L 12/66; H04L 12/56

(52) U.S. Cl. 370/352; 370/401

(57) ABSTRACT

A method for dialing an Internet protocol phone via a GPRS network is disclosed. First, a calling side unit issues a request signal for communication to a receiving side unit, wherein the request signal for communication includes a calling side IP address and a calling side communication port. Then, the receiving side user receives the request signal for communication and sends back a responding user datagram protocol (UDP) packet to the calling side unit, according to the calling side communication port, in which the responded UDP packet includes the calling side IP address of the calling side unit. Next, the calling side unit receives the UDP packet from the calling side IP communication port, and begins to transmit and receive the UDP packet carrying the voice digital data with the receiving side unit, so as to perform the communication via the Internet protocol phone. The present invention allows the user to easily dial the Internet protocol phone with a reduction of the communication cost.

### BACKGROUND OF THE INVENTION

1. Field of Invention

The present invention relates to a method for dialing an Internet protocol phone (IP phone/I-phone). More particularly, the present invention relates to a method for dialing an Internet protocol phone by using the network of a general packet radio service (GPRS) as the method of transmission.

2. Description of Related Art

The developments in the telecommunications technology have allowed people at difference locations to communicate with each other via the telephone system. The connection of telephones typically is set up through the system of a public switched telephone network (PSTN). Although the use of the telephone has improved the methods of communication over distance, the cost can be expensive, particularly, the cost for a long distance call or an international call.

The technology of the Internet protocol phone (IP phone/I-phone) therefore has been developed and used in the market. The Internet protocol phone uses the Internet or the computer network to take place of a part or the whole of the PSTN. The main technology needed is to convert the voice signal into digital data, compress the digital data, and then transmit the compressed data in the form of an IP packet to the receiver at the far end through the Internet or the computer network. The receiving end then decompresses the IP packet and recovers the original voice signal. In this manner, the function of the telephone system can be performed. Thus, the Internet protocol phone can achieve the purpose of long-distance communication, and reduce the high phone charges.

According to the different communication methods for the Internet protocol phone, it can be categorized into three types, computer system to computer system (PC to PC), computer system to phone (PC to phone), and phone to phone. Referring to FIG. 1, it is a schematic drawing of the conventional system and the network used by the Internet protocol phone. As shown in FIG. 1, the computer system 101 and the computer system 105 can be connected to the Internet respectively through the server 103 and the server 107, which are provided by the Internet service provider (ISP). The phone 111 and the phone 121 are respectively connected to the PSTN 113 and the PSTN 123.

As shown in FIG. 1, if the computer system 101 is to be connected to the computer system 105 through the Internet protocol phone, the phone 111 needs to first dial a phone number of the IP, such as an IP address or a specific ID. It is then connected to the computer system 105 further through the server 103 and the Internet 100, so that the function of the Internet protocol phone can be performed. If the computer system 101 is to be connected to the phone 111 by the manner of the Internet protocol phone, the computer system 101 needs to first dial an additional number set by the ISP and the phone number of the phone 111. Then, it is connected, via the server 103 and the Internet 100, to the Internet telephony gateway (ITG) 115, which is provided by the Internet telephony service provider (ITSP). The ITG 115 is used to make the conversion between the IP packet and the voice signal. Therefore, this ITG 115 is to convert the IP packet, which is transmitted from the computer system 101, into the voice signals. Then the voice signals are further transmitted to the phone 111 through the PSTN 113. In this manner, the computer system 101 and the phone 111 can process the communication. Additionally, the connection principle of the Internet protocol phone between the phone 111 and the phone 121 is the same as the foregoing connection.

Although the cost of the Internet protocol phone is much cheaper than the cost of the phone charge using only the PSTN in connection, an IP phone number still needs to be dialed first, in the actual operation. Then, the server is used to make the connection. Furthermore, the popular mobile communication devices, such as the cellular phone still cannot be used to dial the Internet protocol phone, and thus, it still cannot reduce the communication cost for the user who uses the mobile communication device as their main communication tool.

### SUMMARY OF THE INVENTION

It is an objective of the present invention to provide a method for dialing an Internet protocol phone by using a GPRS network. The method of the present invention allows the user with a mobile communication device to easily dial the Internet protocol phone. The communication cost can be greatly reduced.

In accordance with the objective of the present invention, a method for dialing an Internet protocol phone is provided. The method allows a calling side unit to dial the Internet protocol phone via the GPRS network to a receiving side unit, wherein the calling side unit and the receiving side unit have a calling side IP address and a receiving side IP address respectively. In the present invention, first the calling side unit issues a request signal for communication to the receiving side unit, in which the request signal for communication includes a calling side IP address and a calling side communication port. Then, the receiving side user receives the request signal for communication, which contains the calling side IP address and the calling side communication port. The receiving side unit then converts the user's voice into a first voice digital data stream, and compresses and packs the first voice digital data stream into at least one user datagram protocol (UDP) packet, which has the calling side IP address. Next, the receiving side unit sends the UDP packet to the calling side unit via the GPRS network according to the calling side IP address and the calling side IP communication port. The calling side unit then receives the UDP packet from the calling side IP communication port, and performs the unpack action or the decompressing action into a second voice digital data stream. The second voice digital data stream is again decoded into a user's voice, which is provided to the calling side unit. The calling side unit starts to transmit and receive the UDP packet carrying the voice digital data with the receiving side unit, so as to perform the communication via the Internet protocol phone.

### BRIEF DESCRIPTION OF THE DRAWINGS

The accompanying drawings are included to aid in the understanding of the invention, and are incorporated in and constitute a part of this specification. The drawings illustrate preferred embodiment of the invention, and together with the description, serve to explain the principles of the invention. The following description is made with reference to the accompanying drawings.

FIG. 1 is a schematic drawing of the conventional communication system and the network used by the Internet protocol phone;

FIG. 2 is a schematic drawing of a network system for the connection of a mobile communication device with the GSM and GPRS network;

FIG. 3 is a flow diagram, schematically illustrating the process flow of dialing the Internet protocol phone, according to one preferred embodiment of the present invention;

FIG. 4 is a flow diagram, schematically illustrating the process flow for transmitting the UDP packet carrying the voice digital data in the method shown in FIG. 3, according to one preferred embodiment of the present invention; and

FIG. 5 is a flow diagram, schematically illustrating the process flow for receiving the UDP packet carrying the voice digital data in the method shown in FIG. 3, according to one preferred embodiment of the present invention.

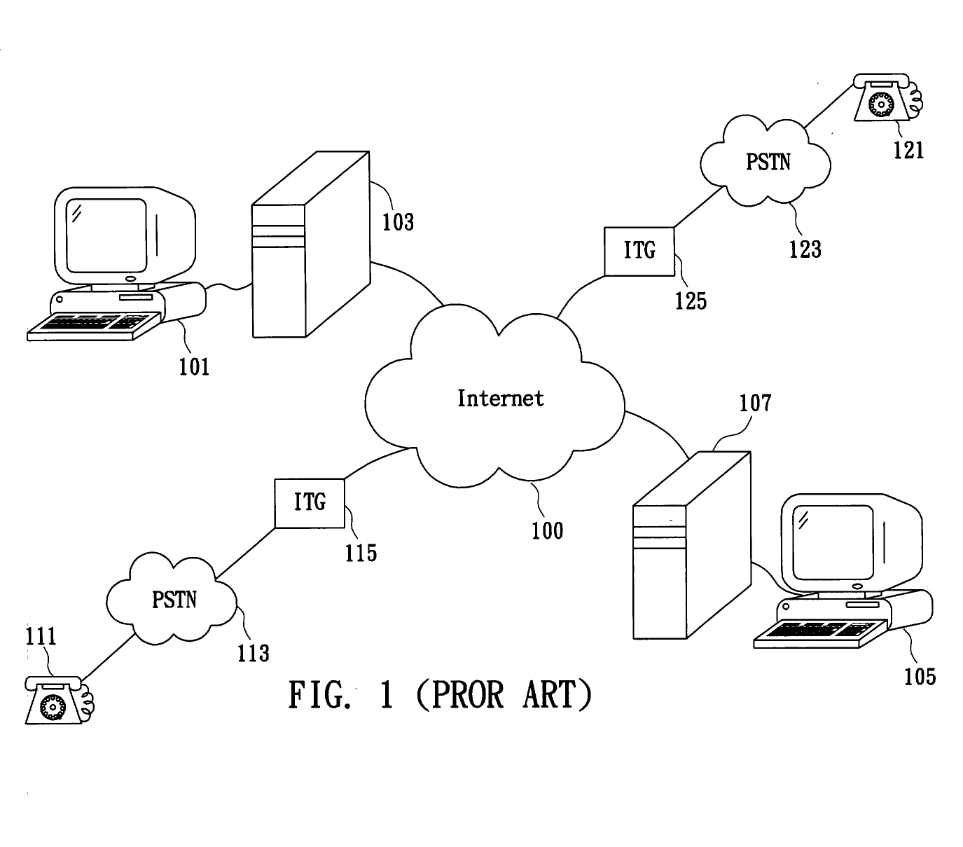

### DESCRIPTION OF THE PREFERRED EMBODIMENTS

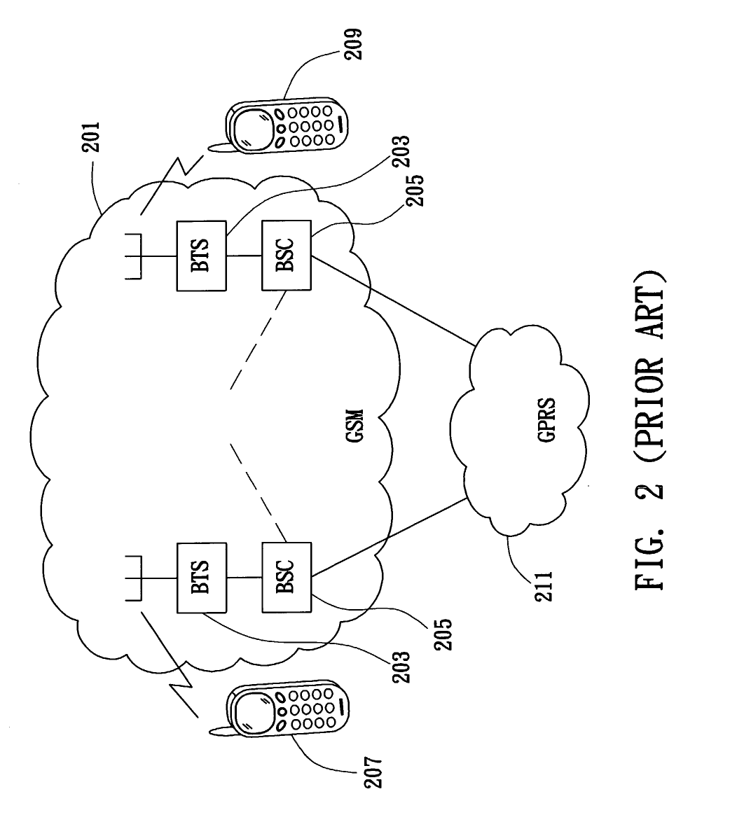

For the current situation, the cellular phone systems used in most of areas are all taking the global system for mobile communication (GSM) system that is proposed by the Nordic Post and Institution of Telephone and Telegraph. As shown in FIG. 2, the GSM 201 has a base transceiver station (BTS) 203 and a base station controller (BSC) 205. The BTS 203 is used to transmit and receive the wireless signal between the GSM 201 and the mobile communication device. Also and, the BSC 205 is used to manage and control the BTS 203. As a result, the mobile communication device transmits the wireless signals to the BTS 203. The BTS 203 then transmits the wireless signals to the GSM 201 again via BSC 205. In this manner, the mobile communication device then can make use of the GSM 201 to have the wireless connection for voice communication.

As shown in FIG. 2, under the structure of the GSM 201, the European Telecommunication Standards Institute has developed a general packet radio service (GPRS) network 211, so as to provide the service for transmitting digital data. The feature of the GPRS network 211 is that the data can be divided into a number of packets and all of the packets can be transmitted at the same time. As a result, the transmission speed is rather fast.

The method for dialing the Internet protocol phone A in one preferred embodiment of the present invention is based on the system architecture as shown in FIG. 2, in order to provide the calling side unit 207 with the function to dial the Internet protocol phone to the receiving side unit 209 for a communication through the GPRS network. The calling side unit 207 and the receiving side unit 209 are involved in the system of GSM 201 and each one respectively has a phone number. Thus, the calling side unit 207 and the receiving side unit 209 can use the GSM 201 to dial the phone number for the opposite side, so that a voice communication or a message transmission can be made. In addition, the calling side unit 207 and the receiving side unit 209 can be a mobile communication device, such as a cellular phone or a personal digital assistant (PDA) device.

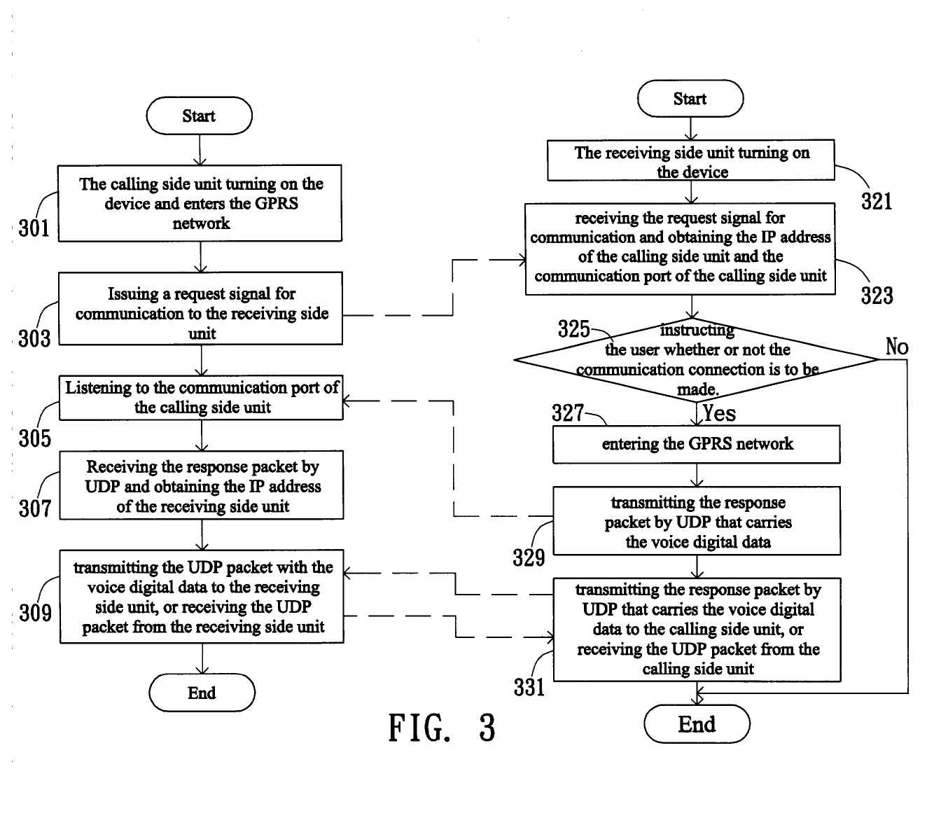

Also, referring to FIG. 3 at the same time, it is a flow diagram, schematically illustrating the process flow of dialing the Internet protocol phone, according to one preferred embodiment of the present invention. The step 301, the step 303, the step 305, the step 307, and the step 309 are the operating procedure flow for the calling side unit 207, while the step 321, the step 323, the step 325, the step 327, the calling side unit 329, and the step 331 are the operating procedure flow for the receiving side unit 209, according to the method of the present invention.

As shown in FIG. 3, the calling side unit 207 and the receiving side unit 209 are respectively at the step 301 and the step 321 to turn on the devices and enter the GSM 201, in which the calling side unit 207 further enters the GPRS network 211 and obtain an Internet protocol (IP) address of the calling side unit. Then, the step 303 is performed.

In the step 303, the calling side unit 207 makes use of the GSM 201 to issue a request signal for communication, to the phone number of the receiving side unit 209, in which this request signal for communication is a connection request that is made by the calling side unit 207 to request the receiving side unit 208 to set up the Internet protocol phone. The connection request includes a calling side IP address and a calling side communication port. Then the calling side unit 207 enters the step 305 to listen from the calling side communication port and wait for a response from the receiving side unit 209.

In the step 323, the receiving side unit 209 receives the request signal for communication, which is transmitted by the calling side unit 207, and also obtains the calling side IP address and the calling side communication port. Next, in the step 325, the receiving side unit 209 provides the user the choice of entering the Internet protocol phone or not. If is the user chooses to continue, then the method of the present invention performs the step 327. If not, then the method goes to an end.

When the user of the calling side unit 209 agrees to have the phone connection with the calling side unit 207 then the procedure goes to the step 327. The receiving side unit 209 enters the GPRS network 211, and obtains a receiving side IP address. Then ,the step 329 is performed immediately.

In the step 329, the receiving side unit 209 then converts the voice signal into a voice digital data stream and compresses and packs the voice digital data stream into at least one response packet by the user datagram protocol (UDP), wherein the response packet by UDP includes the foregoing receiving side IP address. Then, the receiving side unit 209 transmits this response packet by UDP to the calling side unit 207 via the GPRS network 211, according to the calling side IP address and the calling side communication port.

At this time, the calling side unit 207 enters the step 307 to receive the response packet by UDP, which is transmitted by the receiving side unit 209, from the calling side communication port, and then unpacks and decompresses the response packet by UDP into a voice digital data stream. The voice digital data stream is then further decoded into the user's voice for the user of the calling side unit 207, wherein the calling side unit 207 obtains the receiving IP address of the receiving side unit 209 through this response packet by UDP.

Next, the calling side unit 207 and the receiving side unit 209 respectively perform the step 309 and the step 331. The calling side unit 207 and the receiving side unit 209 begin to convert the corresponding user's voice into the voice digital data in UDP packets, and send them to the opposite side unit. Also, the voice digital data in UDP packets are received from the opposite side unit and converted into the user's voice. By this method, the calling side unit 207 and the receiving side unit 209 can then start to perform the voice communication via the Internet protocol phone.

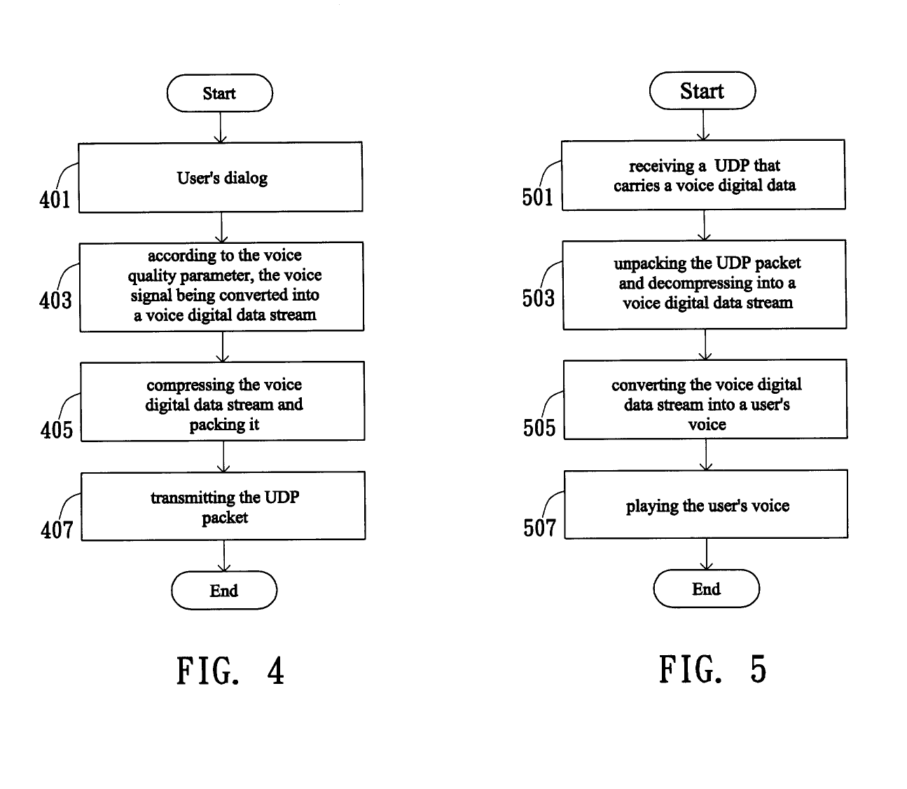

With respect to the step 309 and the step 331, the method for the calling side unit 207 or the receiving side unit 209 to transmit the voice digital data in UDP packets is shown in FIG. 4. Referring to FIG. 4, in the step 401, the users start to talk. Then, in the step 403, according to a voice quality parameter that is preset by the user, the user's voice is converted into a voice digital data stream. The voice quality parameter is used to determine the voice quality for the voice digital data stream. This voice quality parameter can be, for example, a sampling rate parameter or a resolution parameter.

Then in the following step 405, the foregoing voice digital data stream is compressed and packed into at least one UDP packet. Then, immediately in the step 407, the UDP packet is transmitted according to the IP address of the opposite side unit.

In addition to the step 309 and step 331, the method for the calling side unit 207 or the receiving side unit 209 to receive and process the UDP packets having the voice digital data is shown in FIG. 5. Referring to FIG. 5 in the step 501, the UDP packets having the voice digital data, which are transmitted by the opposite side unit, are first received, and then the step 503 is performed.

In the step 503, the foregoing UDP packets are decompressed into a voice digital data stream. Then in the step 505, the voice digital data stream is further decoded into the user's voice. Also and in the step 507, the user's voice is played.

In summary of the foregoing description of the preferred embodiment of the present invention, the disclosed method for dialing the Internet protocol phone has the following advantages.

1. The communication cost for the user of a mobile communication device can be greatly saved. The present invention employs the GPRS network for transmission, and the owner of the GPRS network charges the fee according the amount of digital data having been transmitted. In this manner, the cost can precisely reflect the actual amount used by the user, so as to further save the cost by the user.

2. The dialing procedure to the Internet protocol phone is simplified. With respect to a user, it only needs to issue a request signal for communication, and then a dialogue between the users via the Internet protocol phone can be set up. It is very convenient.

3. The communication quality can be freely adjusted. The user can set the voice quality parameters, according to the actual need and the status of the GPRS network, so as to adjust the communication quality to the proper condition.

4. The connection is easy. The method of the present invention does not require dialing an additional number nor going through the ISP server. Instead, the present invention uses the connection manner of peer-to-peer to implement the technology in Internet protocol phone.

It will be apparent to those skilled in the art that various modifications and variations can be made to the structure of the present invention without departing from the scope or spirit of the invention. In view of the foregoing description, it is intended that the present invention covers the modifications and variations of this invention and the scope of the following claims should be accorded the broadest interpretation so as to encompass all such modifications and variations.

What is claimed is:

1. A method for dialing an Internet protocol phone (IP phone/I-phone), suitable for allowing a calling side unit to dial the Internet protocol phone to a receiving side unit via a general packet radio service (GPRS) network, wherein the calling side unit and the receiving side unit are involved in the same one of a global system for mobile communication (GSM), the method comprising:
the calling side unit entering the GPRS network, and obtaining an Internet protocol (IP) address of the calling side unit;
the calling side unit using the GSM to issue a request signal for communication to the receiving side unit, wherein the request signal for communication comprises the IP address of the calling side unit and a communication port of the calling side unit;
the receiving side unit receiving the request signal for communication, and entering the GPRS network, and obtaining an IP address of the receiving side unit;
the receiving side unit converting a voice signal of a user of the receiving side unit into a first voice digital data stream, wherein the first voice digital data stream is also compressed and packed into at least one response packet by a user datagram protocol (UDP), wherein the at least one response packet by the UDP includes the IP address of the receiving side unit;
the receiving side unit transmitting the response packet by the UDP to the calling side unit via the GPRS network, according to the IP address of the calling side unit and the communication port of the calling side unit;
the calling side unit receiving the response packet by the UDP from the communication port of the calling side unit, and unpacking and decompressing the response packet by the UDP into a second voice digital data stream, wherein the second voice digital data stream is decoded into the user's voice signal that is further provided to the calling side unit; and
the calling side unit starting to transmit and receive the packet by the UDP, which carries the voice digital data, to and from the receiving side unit by each other via the IP address of the receiving side unit included in the response packet by the UDP, so as to perform a dialogue via the Internet protocol phone.

2. The method according to claim 1, wherein the calling side unit is a mobile communication device.

3. The method according to claim 1, wherein the receiving side unit is a mobile communication device.

4. A method for dialing an Internet protocol phone (IP phone/I-phone), suitable for allowing a calling side unit to dial the Internet protocol phone to a receiving side unit via a general packet radio service (GPRS) network, wherein the calling side unit and the receiving side unit respectively have an Internet protocol (IP) address of the calling side unit and an IP address of the receiving side unit, the method comprising:
the calling side unit issuing a request signal for communication to the receiving side unit, wherein the request signal for communication comprises the IP address of the calling side unit and a communication port of the calling side unit;
the receiving side unit receiving the request signal for communication;
the receiving side unit converting a voice signal of a user of the receiving side unit into a first voice digital data stream, wherein the first voice digital data stream is also compressed and packed into at least one response packet by a user datagram protocol (UDP), wherein the at least one response packet by the UDP includes the IP address of the receiving side unit; the receiving side unit transmitting the response packet by the UDP to the calling side unit via the GPRS network, according to the IP address of the calling side unit and the communication port of the calling side unit;
the calling side unit receiving the response packet by the UDP from the communication port of the calling side unit, and unpacking and decompressing the response packet by the UDP into a second voice digital data stream, wherein the second voice digital data stream is decoded into the user's voice signal that is further provided to the calling side unit; and
the calling side unit starting to transmit and receive the packet by the UDP, which carries the voice digital data, to and from the receiving side unit by each other via the IP address of the receiving side unit included in the response packet by the UDP, so as to perform a dialogue via the Internet protocol phone.

5. The method according to claim 4, wherein in the step of the calling side unit issuing a request signal for communication to the receiving side unit, the calling side unit uses a GSM to issue the request signal for communication to the receiving side unit.

6. The method according to claim 4, wherein the calling side unit is a mobile communication device.

7. The method according to claim 4, wherein the receiving side unit is a mobile communication device.

8. A method of dialing an Internet protocol phone (IP phone/I-phone) using a general packet radio service (GPRS) network, the method comprising:
(a) a calling side unit issuing a request signal for communication to a receiving side unit, wherein the request signal for communication comprises an Internet protocol (IP) address of the calling side unit and a communication port of the calling side unit;
(b) the receiving side unit receiving the request signal for communication;
(c) the receiving side unit transmitting a response packet by a user datagram protocol (UDP) to the calling side unit, according to the IP address of the calling side unit and the communication port of the calling side unit in the request signal for communication, wherein the response packet by the UDP includes an IP address of the receiving side unit with respect to the receiving side unit;
(d) the calling side unit receiving the response packet by the UDP from the communication port of the calling side unit; and
(e) the calling side unit starting to transmit and receive the packet by the UDP, which carries a voice digital data, to and from the receiving side unit by each other via the IP address of the receiving side unit included in the response packet by the UDP, so as to perform a dialogue via the Internet protocol phone.

9. The method according to claim 8, wherein in the step of (a), the calling side unit uses a GSM to issue the request signal for communication to the receiving side unit.

10. The method according to claim 8, wherein the step of (e) about the calling side unit starting to transmit the packet by the UDP, which carries the voice digital data, to the receiving side unit further comprises:
(e1) according to a voice quality parameter, which is preset by a user, a user's voice signal with respect to the calling side unit being converted into a voice digital data stream, wherein the voice quality parameter is used to determine a voice quality of the voice digital data stream;
(e2) compressing the voice digital data stream and packing into at least one UDP packet; and
(e3) according to the IP address of the receiving side unit, the least one UDP packet being transmitted to the receiving side unit.

11. The method according to claim 10, wherein the voice quality parameter is a parameter of sampling rate.

12. The method according to claim 10, wherein the voice quality parameter is a parameter of sampling resolution.

13. The method according to claim 8, wherein the step of (e) about the calling side unit starting to receive the packet by the UDP, which carries the voice digital data, from the receiving side unit further comprises:
(e1) the calling side unit receiving a UDP packet that is transmitted by the receiving side unit;
(e2) unpacking the UDP packet and decompressing into a voice digital data stream; and
(e3) decoding the voice digital data stream into a user's voice.

14. The method according to claim 8, wherein the calling side unit is a mobile communication device.

15. The method according to claim 8, wherein the receiving side unit is a mobile communication device.

16. A method for a calling side unit to dial an Internet protocol phone (IP phone/I-phone) using a general packet radio service (GPRS) network, the method comprising:
(a) the calling side unit issuing a request signal for communication to a receiving side unit, wherein the request signal for communication comprises an Internet protocol (IP) address of the calling side unit and a communication port of the calling side unit;
(b) the calling side unit receiving a response packet by a user datagram protocol (UDP), which is transmitted by the receiving side unit, from the communication port of the calling side unit, wherein the packet by the UDP includes an IP address of the receiving side unit; and
(c) the calling side unit transmitting a UDP packet with a voice digital data to the receiving side unit, according to the IP address of the receiving side unit carried by the response packet by the UDP, and receiving a UDP packet with a voice digital data that is transmitted by the receiving side unit.

17. The method according to claim 16, wherein between the step of (a) and the step of (b), the method further comprises:
(a1) the calling side unit listening from the communication port of the calling side unit.

18. The method according to claim 16, wherein in the step of (a), the calling side unit uses a GSM to issue the request signal for communication to the receiving side unit.

19. The method according to claim 16, wherein the step of (c) about the calling side unit transmitting the packet by the UDP, which carries the voice digital data, to the receiving side unit further comprises:
(c1) according to a voice quality parameter, which is preset by a user, a user's voice signal with respect to the calling side unit being converted into a voice digital data stream, wherein the voice quality parameter is used to determine a voice quality of the voice digital data stream;
(c2) compressing the voice digital data stream and packing into at least one UDP packet; and
(c3) according to the IP address of the receiving side unit, the least one UDP packet being transmitted to the receiving side unit.

20. The method according to claim 19, wherein the voice quality parameter is a parameter of sampling rate.

21. The method according to claim 19, wherein the voice quality parameter is a parameter of sampling resolution.

22. The method according to claim 16, wherein the step of (c) about the calling side unit receiving the packet by the UDP, which carries the voice digital data, from the receiving side unit further comprises:
(c1) receiving a UDP packet that is transmitted by the receiving side unit;
(c2) unpacking the UDP packet and decompressing into a voice digital data stream; and
(c3) decoding the voice digital data stream into a user's voice.

23. The method according to claim 16, wherein the calling side unit is a mobile communication device.

24. The method according to claim 16, wherein the receiving side unit is a mobile communication device.

25. A method for a receiving side unit to receive an Internet protocol phone (IP phone/I-phone) using a general packet radio service (GPRS) network, the method comprising:
(a) the receiving side unit receiving a request signal for communication from a calling side unit, wherein the request signal for communication comprises an Internet protocol (IP) address of the calling side unit and a communication port of the calling side unit;
(b) the receiving side unit transmitting a response packet by a user datagram protocol (UDP) to the calling side unit, according to the IP address of the calling side unit and the communication port of the calling side unit carried in the request signal for communication, wherein the packet by the UDP includes an IP address of the receiving side unit; and
(c) the receiving side unit transmitting a UDP packet with a voice digital data to the calling side unit and receiving a UDP packet with a voice digital data that is transmitted by the calling side unit.

26. The method according to claim 25, wherein in the step of (a), the receiving side unit uses a GSM to receive the request signal for communication transmitted by the calling side unit.

27. The method according to claim 25, wherein the step of (c) about the receiving side unit transmitting the UDP packet with the voice digital data to the calling side unit further comprises:
(c1) according to a voice quality parameter, which is preset by a user, a user's voice signal with respect to the receiving side unit being converted into a voice digital data stream, wherein the voice quality parameter is used to determine a voice quality of the voice digital data stream;
(c2) compressing the voice digital data stream and packing into at least one UDP packet; and
(c3) according to the IP address of the calling side unit, the least one UDP packet being transmitted to the calling side unit.

28. The method according to claim 27, wherein the voice quality parameter is a parameter of sampling rate.

29. The method according to claim 27, wherein the voice quality parameter is a parameter of sampling resolution.

30. The method according to claim 25, wherein the step of (c) about receiving the UDP packet, which carries a voice digital data, transmitted from the calling side unit further comprises:
(c1) receiving a UDP packet that is transmitted by the calling side unit;
(c2) unpacking the UDP packet and decompressing into a voice digital data stream; and
(c3) decoding the voice digital data stream into a user's voice.

31. The method according to claim 25, wherein the calling side unit is a mobile communication device.

32. The method according to claim 25, wherein the receiving side unit is a mobile communication device.
